(19) United States
(12) Patent Application Publication
(10) Pub. No.: US 2018/0184090 A1
(43) Pub. Date: Jun. 28, 2018

(54) BINARY ARITHMETIC CODING APPARATUS AND METHOD

(71) Applicant: MStar Semiconductor, Inc., Hsinchu Hsien (TW)

(72) Inventors: Pai-Chin LIU, Hsinchu Hsien (TW); He-Yuan LIN, Hsinchu Hsien (TW)

(21) Appl. No.: 15/842,986

(22) Filed: Dec. 15, 2017

Related U.S. Application Data
(60) Provisional application No. 62/438,472, filed on Dec. 23, 2016.

(51) Int. Cl. H04N 19/13; H04N 19/70

(52) U.S. Cl. CPC H04N 19/13; H04N 19/70

(57) ABSTRACT

A binary arithmetic coding apparatus is implemented in a video encoder chip. The binary arithmetic coding apparatus outputs a code word according to a syntax element value, and includes a look-up table (LUT), a suffix generator and a combiner. The LUT outputs a first binary string according to the syntax element value. The suffix generator performs exp-Golomb binarization on the syntax element value to generate a second binary string. When the syntax element value is smaller than or equal to a threshold, the first binary string is outputted as the code word. When the syntax element value is greater than the threshold, the combiner combines the first binary string and the second binary string to form the code word.

This application claims the benefit of U.S. Provisional Application Ser. No. 62/438,472, filed Dec. 23, 2016, the subject matter of which is incorporated herein by reference.

### BACKGROUND OF THE INVENTION

### Field of the Invention

The invention relates in general to a binary arithmetic coding apparatus and method, and more particularly to a binary arithmetic coding apparatus and method applied in a video encoder chip.

### Description of the Related Art

Video compression and transmission have long since been the development focus of the electronics industry. Original data of video is formed by a colossal number of video frames, each of which includes a colossal number of pixels. Transmitting these video signals without compression results in a tremendous waste in both circuit area and bandwidth, and is in fact infeasible. Thus, there are numerous video compression standards developed in response, e.g., Moving Picture Experts Group (MPEG) and H.264 video compression standards. These video compression standards use entropy coding to perform encoding. Entropy coding uses statistical characteristics, and represents data appearing more frequently by shorter code words and data appearing less frequently by longer code words, thus obtaining a higher compression rate. Binary arithmetic coding is a type of entropy coding. However, implementing binary arithmetic coding on a semiconductor chip needs to consider issues of circuit area occupied and coding efficiency. Therefore, there is a need for a binary arithmetic coding circuit that attends to both circuit area occupied and encoding efficiency.

### SUMMARY OF THE INVENTION

It is an object of the present invention to provide a binary arithmetic coding apparatus applied in a video encoder chip. The binary arithmetic coding apparatus is capable of generating exp-Golomb arithmetic codes by two approaches—a look-up table (LUT) and arithmetic. The LUT provides an advantage of being fast in speed, and the arithmetic provides an advantage of saving circuit area. The binary arithmetic coding apparatus is capable of maintaining balance between these two advantages.

It is another object of the present invention to provide a binary arithmetic coding apparatus applied in a video encoder chip. The binary arithmetic coding apparatus is capable of separately processing a prefix and a suffix of an exp-Golomb binary code, providing more efficient code acquisition.

A binary arithmetic coding apparatus implemented in an encoder chip is provided according to an embodiment of the present invention. The binary arithmetic coding apparatus outputs a code word according to a syntax element value, and includes an LUT, a suffix generator and a combiner. The LUT outputs a first binary string according to the syntax element value, and is provided with two binarization methods that are respectively unary binarization and exp-Golomb binarization. The suffix generator performs exp-Golomb binarization according to the syntax element value to generate a second binary string. The combiner is for combining the first binary string and the second binary string. When the syntax element value is smaller than or equal to a threshold, the first binary string is outputted as the code word. When the syntax element value is greater than the threshold, the combiner combines the first binary string and the second binary string to form the code word.

A binary arithmetic coding apparatus implemented in a video encoder chip is provided according to another embodiment of the present invention. The binary arithmetic coding apparatus outputs a code word according to a syntax element value, and includes an LUT, a suffix generator and a multiplexer. The LUT outputs a first binary string according to the syntax element value, and is provided with two binarization methods that are respectively unary binarization and exp-Golomb binarization. The suffix generator performs exp-Golomb binarization according to the syntax element value to generate a second binary string. The multiplexer receives the first binary string and the second binary string as an input. When the syntax element value is smaller than or equal to a threshold, the multiplexer selects and outputs the first binary string. When the syntax element value is greater than the threshold, the multiplexer sequentially selects and outputs the first binary string and the second binary string.

A binary arithmetic coding method implemented in a video encoder chip is provided according to yet another embodiment of the present invention. The binary arithmetic coding method outputs a code word according to a syntax element value, and includes steps of: receiving a syntax element value; determining whether the syntax element value is greater than a threshold; utilizing an LUT to output a binary string as the code word when the syntax element value is smaller than or equal to the threshold; and utilizing the LUT to output a prefix, utilizing a suffix generator to generate a suffix, and combining the prefix and the suffix to form the code word when the syntax element value is greater than the threshold.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of an encoder using CABAC binary arithmetic coding;

FIG. 2 is an example of a look-up table (LUT) I;

FIG. 3 is an example of an LUT II;

FIG. 4 is a circuit block diagram associated with a combiner; and

FIG. 5 is a flowchart of binary arithmetic coding according to an embodiment.

### DETAILED DESCRIPTION OF THE INVENTION

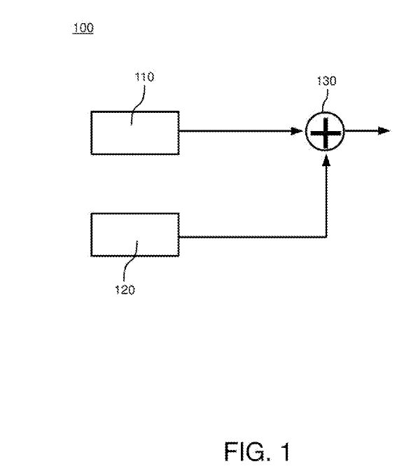

FIG. 1 shows a block diagram of an encoder using context-based adaptive binary arithmetic coding (CABAC), which can be used for H.264 coding. Referring to FIG. 1, an encoder 100 includes a look-up table (LUT) 110, a suffix generator 120, and a combiner 130. In some embodiments, the encoder 100 is also applicable to MPEG coding. The encoder 100 can be implemented in a video encoder chip, e.g., a television chip, a cell phone chip, a set-top box (STB) chip, and any chip that needs video decoding.

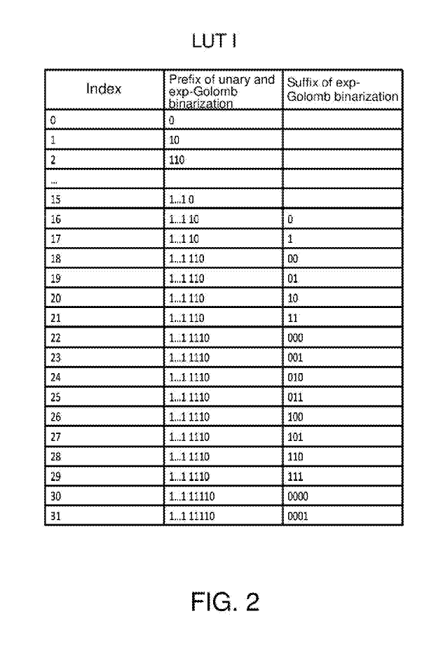

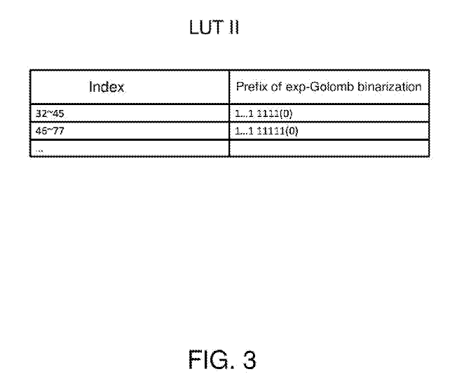

FIG. 2 shows an example of an LUT I. FIG. 3 shows an example of an LUT II. Referring to FIG. 2, in some embodiments, an LUT includes binary strings generated by unary binarization as well as binary strings generated by Golomb binarization. For example, in the LUT I, when an index, i.e., a syntax element value, is smaller than or equal to 15, a binary string outputted is a unary code; when the index is greater than 15, the binary string outputted is an exp-Golomb code. It should be noted that, the value 15 is merely an example, and a designer can designate, from a feasible range, an index as a border value of unary binarization and exp-Golomb binarization. In this embodiment, an exp-Golomb code includes a prefix and a suffix. In the LUT I, the prefix column includes multiple prefixes, and the suffix column includes multiple suffixes. From an appropriate range, each index can find corresponding prefix and suffix to form an exp-Golomb binary code.

Referring to FIG. 3, in some embodiments, when the syntax element value is greater than 31, the LUT II includes prefixes formed by exp-Golomb binarization for further use. It should be noted that, the value 31 is merely an example, and other syntax element values may also be used as border values in other embodiments. The prefix forms a front part of a code word. In this embodiment, the LUT II does not include the suffix, and so the storage space needed by the LUT II can be reduced by excluding the suffix. The suffix of the exp-Golomb binarization can be calculated by using digital logic hardware. Thus, each time a syntax element value greater than 31 is encountered, the prefix of an exp-Golomb code can be obtained from the LUT II, the suffix of the exp-Golomb code can be obtained by a technical solution based on digital logic hardware, and the prefix and the suffix are combined to obtain the final code word.

The suffix generator 120 adopts exp-Golomb binarization. In some embodiments, the suffix generator 120 may be implemented by the pseudo codes below.

```
if (UEG0_input_tmp[10])
  UEG0_output = {1111110, UEG0_input_tmp[9:0]};
else if(UEG0_input_tmp[9])
  UEG0_output = {111110, UEG0_input_tmp[8:0]};
else if(UEG0_input_tmp[8])
  UEG0_output = {11110, UEG0_input_tmp[7:0]};
. . .
else if(UEG0_input_tmp[4])
  UEG0_output = {0, UEG0_input_tmp[3:0]};
else
  UEG0_output = 0;
```

These pseudo codes may form a hardware circuit. For example, these pseudo codes are re-written by a hardware description language (HDL), and are synthesized into a physical circuit to be implemented on a semiconductor chip. In this example, the suffix generator 120 obtains the suffix through logic calculation performed by a physical circuit instead of from the LUT. In this embodiment, UEG0_input in these pseudo codes is an 11-bit input, and UEG0_input_tmp is equal to UEG0_input plus 1. In another embodiment, the suffix generator 120 may also be implemented by an LUT.

Referring to FIG. 3, in some embodiments, 0 in the parenthesis is in fact not stored in the LUT II but is generated by the suffix generator 120 by means of, e.g., the above pseudo codes. In another embodiment, 0 in the parenthesis is in fact stored in the LUT II but not generated by the suffix generator 120. The binary string outputted by the LUT 110 and the binary string outputted by the suffix generator are combined by the combiner 130.

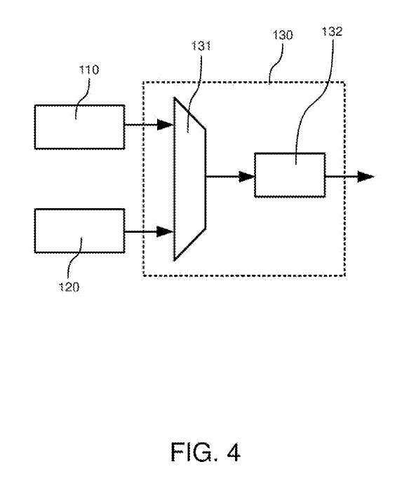

FIG. 4 shows a circuit block diagram associated with the combiner. Referring to FIG. 4, the combiner 130 includes a multiplexer 131 and a first-in-first-out (FIFO) 132. The FIFO 132 is a first-in-first-out buffer or a first-in-first-out memory. The multiplexer 131 controls the output of which the LUT 110 and the suffix generator 120 can enter the FIFO 132. If the syntax element value is smaller than 32, the corresponding binary string in the LUT 110 is inputted into the FIFO 132. If the syntax element value is greater than 31, the corresponding binary string in the LUT 110 is inputted into the FIFO 132, and the binary string generated by the suffix generator 120 is then directly inputted into the FIFO 132. At this point, the corresponding binary string in the LUT 110 is the prefix of an exp-Golomb code and the binary string generated by the suffix generator 120 is the suffix of the exp-Golomb code. A sequence combination of the prefix and the suffix can form a code word. In this embodiment, the LUT 110 includes the LUT I and the LUT II.

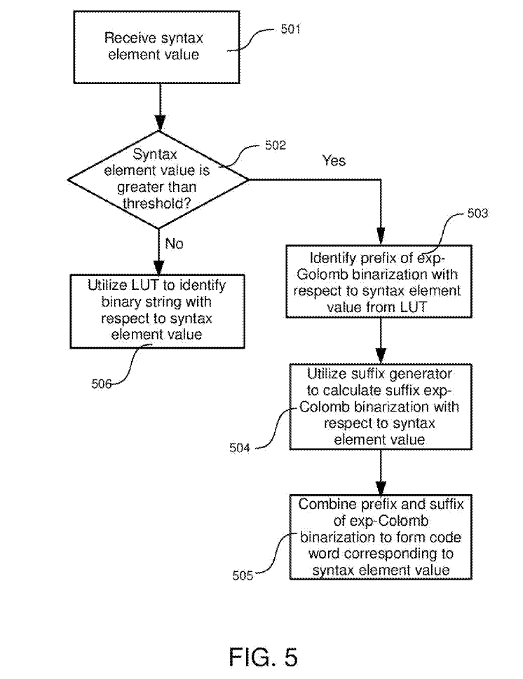

FIG. 5 shows a flowchart of binary arithmetic coding according to an embodiment of the present invention. Referring to FIG. 5, a binary arithmetic coding method is disclosed according to an embodiment of the present invention. The method includes following steps. In step 501, a syntax element value is received. In step 502, it is determined whether the syntax element value is greater than a threshold. In one embodiment, the threshold is 31. If the result of step 502 is affirmative, in step 503, a prefix of exp-Golomb binarization with respect to this syntax element value is identified from an LUT. In step 504, using a suffix generator, a suffix of exp-Golomb binarization with respect to this syntax element value is calculated and generated. In step 505, the prefix and the suffix of the exp-Golomb binarization are combined to form a code word corresponding to the syntax element value. If the result of step 502 is negative, in step 506, a binary string with respect to this syntax element value is identified by using an LUT. The binary string generated in step 506 may be generated by unary binarization or exp-Golomb binarization.

One advantage of an LUT is being fast in speed, and one advantage of arithmetic is saving circuit area. The binary arithmetic coding apparatus of the embodiments of the present invention is capable of maintaining balance between the two advantages above. Further, the embodiments of the present invention are capable of separately processing the prefix and the suffix of exp-Golomb binarization, providing more efficient code acquisition.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A binary arithmetic coding apparatus, implemented in a video encoder chip, outputting a code word according to a syntax element value, comprising:
a look-up table (LUT), outputting a first binary string according to the syntax element value, the LUT being provided with two binarization methods including unary binarization and exp-Golomb binarization;
a suffix generator, performing exp-Golomb binarization according to the syntax element value to generate a second binary string; and
a combiner, for combining the first binary string and the second binary string;
wherein, when the syntax element value is smaller than or equal to a threshold, the first binary string is outputted as the code word; when the syntax element value is greater than the threshold, the combiner combines the first binary string and the second binary string to form the code word.

2. The binary arithmetic coding apparatus according to claim 1, wherein the threshold is 31.

3. The binary arithmetic coding apparatus according to claim 1, further comprising a first-in-first-out (FIFO), the binary arithmetic coding apparatus storing the code word into the FIFO.

4. The binary arithmetic coding apparatus according to claim 1, wherein the LUT comprises a prefix column and a suffix column, and the first binary string comprises a combination formed by a prefix selected from the prefix column and a suffix selected from the suffix column.

5. The binary arithmetic coding apparatus according to claim 4, wherein the suffix column comprises unary binarization and exp-Golomb binarization, and the suffix column comprises exp-Golomb binarization.

6. The binary arithmetic coding apparatus according to claim 1, wherein when the syntax element is smaller than or equal to 15, the first binary string comprises only unary binarization.

7. A binary arithmetic coding apparatus, implemented in a video encoder chip, outputting a code word according to a syntax element value, comprising:
a look-up table (LUT), outputting a first binary string according to the syntax element value, the LUT being provided with two binarization methods including unary binarization and exp-Golomb binarization;
a suffix generator, performing exp-Golomb binarization according to the syntax element value to generate a second binary string; and
a multiplexer, receiving the first binary string and the second binary string as an input;
wherein, when the syntax element value is smaller than a threshold, the multiplexer selects and outputs the first binary string; when the syntax element value is greater than the threshold, the multiplexer sequentially selects and outputs the first binary string and the second binary string.

8. The binary arithmetic coding apparatus according to claim 7, wherein the threshold is 31.

9. The binary arithmetic coding apparatus according to claim 7, further comprising a first-in-first-out (FIFO) that receives an output of the multiplexer.

10. The binary arithmetic coding apparatus according to claim 7, wherein the LUT comprises a prefix column and a suffix column, and the first binary string comprises a combination formed by a prefix selected from the prefix column and a suffix selected from the suffix column.

11. The binary arithmetic coding apparatus according to claim 10, wherein the suffix column comprises unary binarization and exp-Golomb binarization, and the suffix column comprises exp-Golomb binarization.

12. The binary arithmetic coding apparatus according to claim 7, wherein when the syntax element value is smaller than 15, the first binary string comprises only unary binarization.

13. A binary arithmetic coding method, implemented in a video encoder chip, outputting a code word according to a syntax element value, comprising:
receiving the syntax element value;
determining whether the syntax element value is greater than a threshold;
utilizing a look-up table (LUT) to output a binary string as the code word when the syntax element value is smaller than or equal to the threshold, wherein the LUT comprises unary binarization and exp-Colomb binarization; and utilizing the LUT to output a prefix of exp-Golomb binarization, utilizing a suffix generator to generate a suffix of exp-Golomb binarization, and combining the prefix and the suffix to form the code word when the syntax element value is greater than the threshold.

14. The binary arithmetic coding method according to claim 13, wherein the threshold is 31.

15. The binary arithmetic coding method according to claim 13, further comprising:
storing the code word into a first-in-first-out (FIFO).

16. The binary arithmetic coding method according to claim 13, wherein the LUT comprises a prefix column and a suffix column, and the first binary string comprises a combination formed by a prefix selected from the prefix column and a suffix selected from the suffix column.

17. The binary arithmetic coding method according to claim 16, wherein the suffix column comprises unary binarization and exp-Golomb binarization, and the suffix column comprises exp-Golomb binarization.

18. The binary arithmetic coding method according to claim 13, wherein the first binary string comprises only unary binarization when the syntax element is smaller than or equal to 15.
